(19) United States
(12) Patent Application Publication
(10) Pub. No.: US 2013/0290999 A1
(43) Pub. Date: Oct. 31, 2013

(54) INFORMATION PROCESSOR, BROADCAST RECEIVING DEVICE, AND INFORMATION PROCESSING METHOD

(71) Applicants: Toyokazu ITAKURA, Kanagawa (JP); Yoshihiro Ohmori, Tokyo (JP)

(72) Inventors: Toyokazu ITAKURA, Kanagawa (JP); Yoshihiro Ohmori, Tokyo (JP)

(21) Appl. No.: 13/683,513

(22) Filed: Nov. 21, 2012

(30) Foreign Application Priority Data
Apr. 26, 2012 (JP) 2012-101486

(51) Int. Cl. H04N 21/25

(52) U.S. Cl. CPC H04N 21/252
USPC 725/14

(57) ABSTRACT

According to one embodiment, an information processing method includes: acquiring, as a viewing history, contents of a program viewed by each of users; first retrieving, based on a viewing history of a target user among the users, a program corresponding to program preference of the target user, from a viewable program storage storing therein programs that are viewable; second retrieving, based on the viewing history of the target user and viewing histories of users other than the target user among the plurality of users, a similar user having program preference similar to the program preference of the target user, from the users other than the target user; third retrieving, based on a viewing history of the similar user, a program corresponding to the program preference of the similar user, from the viewable program storage; and providing one part or all of the programs retrieved by the first and second retrievings.

### CROSS-REFERENCE TO RELATED APPLICATIONS

This application is based upon and claims the benefit of priority from Japanese Patent Application No. 2012-101486, filed on Apr. 26, 2012, the entire contents of which are incorporated herein by reference.

### FIELD

Embodiment described herein relate generally to an information processor, a broadcast receiving device, and an information processing method.

### BACKGROUND

Conventionally, in a television apparatus, etc., there is used a contents-based filtering technique in which programs corresponding to the preference of a user can be recommended based on programs viewed by the user. Moreover, conventionally, in online shopping, online video on demand (VOD) services, etc., there is used a collaborative-filtering-based filtering technique in which, based on the history of contents viewed/bought by a particular user and the histories of contents viewed/bought by users other than the particular user, users (similar users) having preference similar to that of the particular user are specified, and the contents viewed/bought by the similar users are recommended for the particular user.

When the collaborative-filtering-based filtering technique is used for recommending programs, it is possible to recommend past programs viewed by similar users. However, programs that are currently broadcasted or will be broadcasted in the future cannot be recommended. Thus, programs recommended in the collaborative-filtering-based filtering technique cannot be effectively utilized.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of a configuration example of a television apparatus according to an embodiment;

FIG. 2 is an exemplary view of an example of a function configuration of the television apparatus in the embodiment;

FIG. 3 is an exemplary schematic view of an example of a data configuration of a user information storage illustrated in FIG. 2;

FIG. 4 is an exemplary schematic view of an example of a data configuration of a past program storage illustrated in FIG. 2;

FIG. 5 is an exemplary view of an example of a data configuration of a viewing history storage illustrated in FIG. 2;

FIG. 6 is an exemplary view of an example of a data configuration of a first recommended program storage illustrated in FIG. 2;

FIG. 7 is an exemplary view of an example of a data configuration of a similar user retrieving result storage illustrated in FIG. 2;

FIG. 8 is an exemplary view of an example of a data configuration of a second recommended program storage illustrated in FIG. 2;

FIG. 9 is an exemplary flowchart of steps for recommended program providing processing performed by the television apparatus in the embodiment; and

FIG. 10 is an exemplary view of an action of recommended program providing processing illustrated in FIG. 9.

### DETAILED DESCRIPTION

In general, according to one embodiment, an information processor comprises: a viewing history acquiring module configured to acquire, as a viewing history, program contents of a program viewed by each of a plurality of users; a first retrieving module configured to retrieve, based on a viewing history of a target user among the plurality of users, a program corresponding to program preference of the target user, from a viewable program storage storing therein programs that are viewable; a similar user retrieving module configured to retrieve, based on the viewing history of the target user and viewing histories of users other than the target user among the plurality of users, a similar user having program preference similar to the program preference of the target user, from the users other than the target user; a second retrieving module configured to retrieve, based on a viewing history of the similar user, a program corresponding to the program preference of the similar user, from the viewable program storage; and a providing module configured to provide one part or all of the programs retrieved by the first retrieving module and the second retrieving module.

In the following, embodiments of the information processor, the broadcast receiving device, and the information processing method are described in detail with reference to drawings. The embodiments exemplify a case in which the information processor, the broadcast receiving device, and the information processing method are applied to a television apparatus having television-program receiving and viewing functions. However, the devices to which embodiments are applied are not limited thereto.

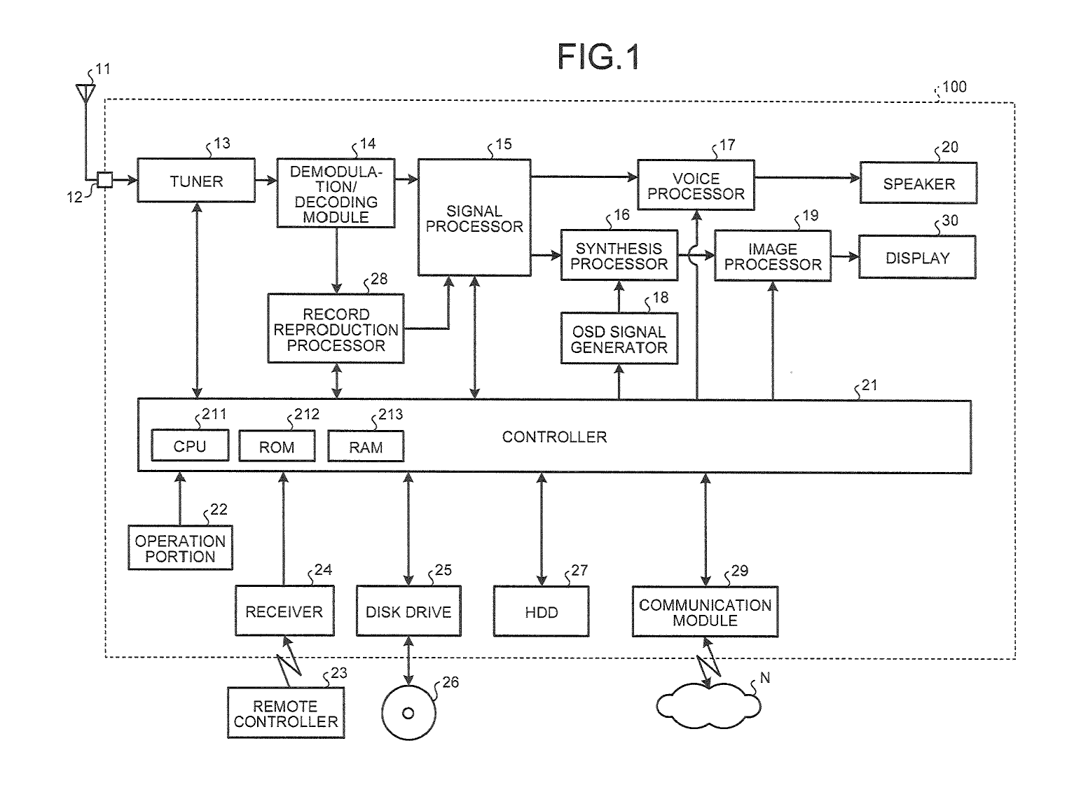

FIG. 1 is a view of a configuration example of a television apparatus 100 according to an embodiment. As illustrated in FIG. 1, in the television apparatus 100, broadcast signals received by an antenna 11 are supplied to a tuner 13 through an input terminal 12, so that a program that is currently broadcasted in a desired channel can be selected.

In the television apparatus 100, the broadcast signals of the program selected at the tuner 13 are supplied to a demodulation/decoding module 14 to restore digital image signals, digital voice signals, etc., and then the restored digital image and voice signals are output to a signal processor 15. The signal processor 15 performs predetermined digital signal processing on each of the digital image signals and digital voice signals supplied from the demodulation/decoding module 14. The signal processor 15 outputs the processed digital image signals to a synthesis processor 16, while it outputs the processed digital voice signals to a voice processor 17.

The synthesis processor 16 superposes, on the digital image signals supplied from the signal processor 15, on screen display (OSD) signals as image signals for superposition such as subtitling, a graphical user interface (GUI) or OSD, which are generated by an OSD signal generator 18, and outputs the resulting signals.

In the television apparatus 100, the digital image signals output from the synthesis processor 16 are supplied to an image processor 19. The image processor 19 converts the input digital image signals into analog image signals in a format that can be displayed at a display 30 at the subsequent stage. In the television apparatus 100, the analog image signals output from the image processor 19 are supplied to the display 30 for image display. The display 30 has a display device such as a liquid crystal display (LCD), and displays the analog image signals output from the image processor 19.

The voice processor 17 converts the input digital voice signals into analog voice signals in a format that can be reproduced at a speaker 20 at the subsequent stage. The analog voice signals output from the voice processor 17 are supplied to the speaker 20 for voice reproduction.

Here, in the television apparatus 100, a controller 21 generally controls all actions of the television apparatus 100 including the above-described various reception actions. The controller 21 comprises a central processing unit (CPU) 211, a read only memory 212 for storing therein programs executed by the CPU 211, and a random access memory (RAM) 213 for providing the CPU 211 with a work area. The CPU 211 cooperates with various programs so as to generally control the action of each module.

To be more specific, the controller 21 receives operation information from an operation portion 22 arranged on the body of the television apparatus 100 or operation information that is sent from a remote controller 23 and received by a receiver 24, and controls each module so as to reflect the operation contents.

The controller 21 obtains an electronic program guide (EPG) based on the signals restored by the demodulation/decoding module 14 and, in response to operation by a viewer through the operation portion 22 or the remote controller 23, supplies the electronic program guide to the OSD signal generator 18 or the image processor 19 so as to provide the viewer with a listing of programs that are currently broadcasted or will be broadcasted. Here, the electronic program guide contains, for each of programs that are currently broadcasted or will be broadcasted, a program ID specifying the program (a broadcasting station and broadcasting time, for example), and program information representing program contents such as the title, the category, the summary and performers of the program.

The controller 21 may be connected to a disk drive 25. An optical disk 26 such as a blue-ray disc (BD) and a digital versatile disk (DVD) can be attached or removed freely on the disk drive 25. The disk drive 25 has a function of recording and reproducing digital data on the optical disk 26 attached.

The controller 21 can control so that, based on an action by a viewer through the operation portion 22 or the remote controller 23, the digital image signals and digital voice signals obtained from the demodulation/decoding module 14 are encrypted and converted into data in a predetermined record format by a record reproduction processor 28, and then the resulting data is supplied to the disk drive 25 for recording it on the optical disk 26.

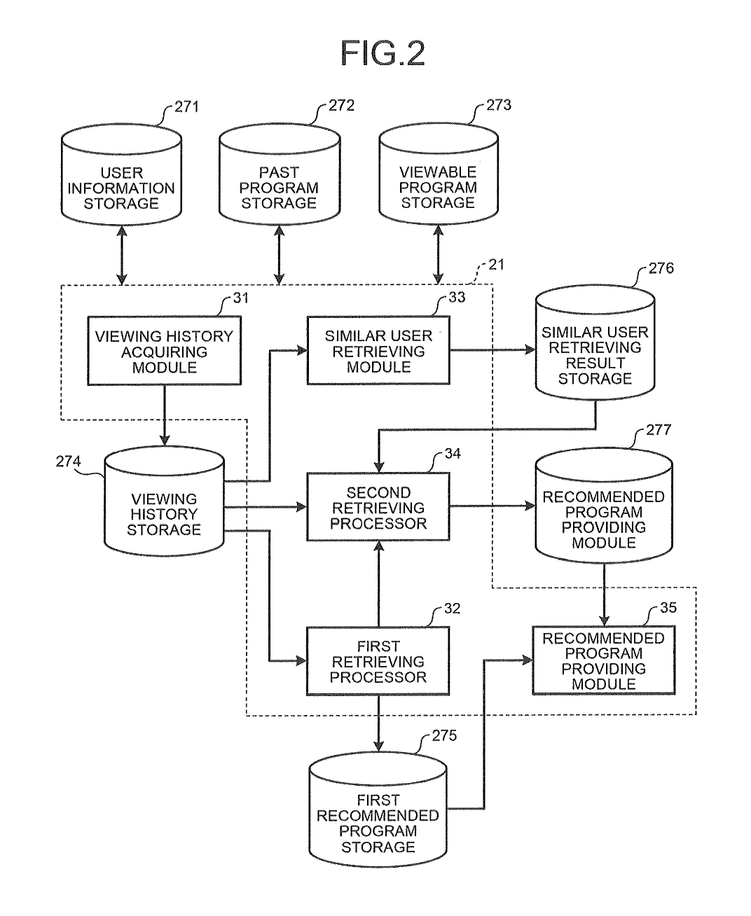

The controller 21 is connected to a hard disk drive (HDD) 27. The HDD 27 may be constituted as an external device. When a viewer specifies a program to be recorded through the operation portion 22 or the remote controller 23, the controller 21 controls so that the digital image signals and digital voice signals of the program that are obtained from the demodulation/decoding module 14 are encrypted and converted into data in a predetermined record format by the record reproduction processor 28, and then the resulting data is supplied to the HDD 27 for recording the program. The HDD 27 has a user information storage 271, a past program storage 272, a viewable program storage 273, a viewing history storage 274, a first recommended program storage 275, a similar user retrieving result storage 276, and a second recommended program storage 277 (see FIG. 2), which are described later.

The controller 21 controls so that, based on an action by a viewer through the operation portion 22 or the remote controller 23, after the program data recorded on the HDD 27 is read out, or the data on the optical disk 26 is read out by the disk drive 25, the data is decoded by the record reproduction processor 28, and then the decoded data is supplied to the signal processor 15 for image display and voice display as described above.

The controller 21 is connected to a communication module 29. The communication module 29 is a communication interface that can be connected to a network N such as the internet. The controller 21 sends and receives various information to and from an external device (not shown) connected to the network N through the communication module 29.

Next, the function configuration of the controller 21 characteristic of the television apparatus 100 is described.

FIG. 2 is a view of an example of the function configuration of the television apparatus 100. In the controller 21 of the television apparatus 100, the CPU 211 cooperates with predetermined programs stored in the ROM 212, etc. so that a viewing history acquiring module 31, a first retrieving processor 32, a similar user retrieving module 33, a second retrieving processor 34, and a recommended program providing module 35 are achieved as function modules, as illustrated in FIG. 2. The television apparatus 100 is provided with the user information storage 271, the past program storage 272, the viewable program storage 273, the viewing history storage 274, the first recommended program storage 275, the similar user retrieving result storage 276, and the second recommended program storage 277, as storages for storing therein various information related to the main function modules.

Here, the user information storage 271 stores the information of each of viewing users of the television apparatus 100. The information stored in the user information storage 271 includes user IDs, names, etc. as identification information for identifying each of users.

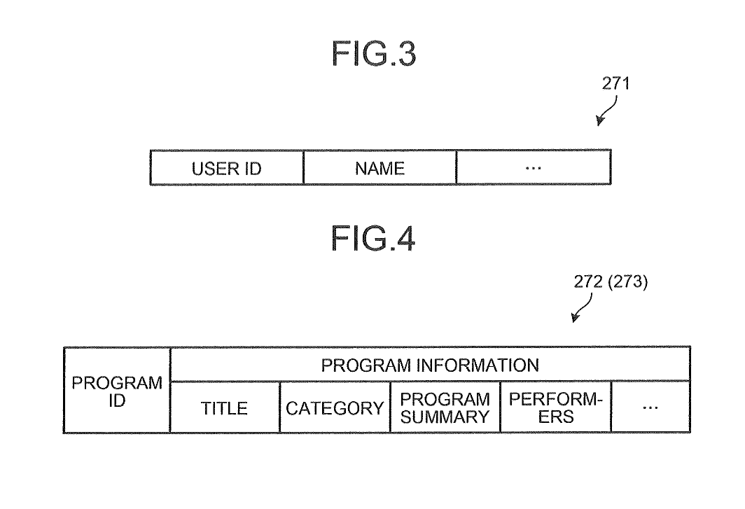

FIG. 3 is a schematic view of an example of a data configuration of the user information storage 271. As illustrated in FIG. 3, the user information storage 271 stores, for each viewing user of the television apparatus 100, the user ID, the name, etc. thereof as user information. In the embodiment, when predetermined login processing is performed for viewing of the television apparatus 100, a user ID is input.

Among programs contained in an obtained electronic program guide, the program IDs and the program information of programs that are broadcasted in the past and cannot be viewed any more are stored successively in the past program storage 272 under control of the controller 21. Among programs contained in an obtained electronic program guide, the program IDs and the program information of viewable programs that are broadcasted currently and will be broadcasted in the future are stored successively in the viewable program storage 273 under control of the controller 21.

FIG. 4 is a schematic view of an example of a data configuration of the past program storage 272. As illustrate in FIG. 4, the past program storage 272 stores the program ID and the program information of each of programs in a manner that they are associated with each other. Here, the program information includes information such as the title, the category, the program summary, and performers of the program.

The controller 21 sequentially moves the program information of programs whose broadcasting is finished from the viewable program storage 273 to the past program storage 272, based on current time (time and data) measured by a clocking device such as a real time clock (RTC). The explanation of the data configuration of the viewable program storage 273 is omitted since the configuration is the same as of the past program storage 272.

The viewing history acquiring module 31 acquires the program ID of a program that is currently viewed in the television apparatus 100 as viewing history information. The viewing history acquiring module 31 stores the acquired viewing history information in the viewing history storage 274 in a manner that it is associated with the user ID that is currently logging in the television apparatus 100. The case in which viewing history information is acquired is not limited to when a currently-broadcasted program is actually viewed. The program ID of a program may be acquired as viewing history information when the program is recorded (or reproduced).

FIG. 5 is a view of an example of a data configuration of the viewing history storage 274. As illustrated in FIG. 5, the viewing history storage 274 stores the user ID and the program ID acquired as viewing history information in a manner that they are associated with each other.

The first retrieving processor 32 retrieves, based on the program information of programs corresponding to the viewing history information of a user for whom a program is to be recommended (hereinafter referred to as a target user) among viewing history information of each of users (user IDs) stored in the viewing history storage 274, the program IDs of programs corresponding to the preference of the target user regarding program contents (hereinafter referred to as program preference) from the viewable program storage 273.

For retrieving processing in the first retrieving processor 32, a contents-based filtering technique can be used. For example, once the first retrieving processor 32 reads out the program information corresponding to each of the program IDs of viewing history information from the past program storage 272, it extracts, as a keyword (hereinafter referred to as a first keyword), a predetermined word such as of a category, performers, etc. from the program information. Then, the first retrieving processor 32 retrieves, from the viewing history storage 274, the program IDs of program information containing a word that has predetermined relation with the first keyword extracted. The “word that has predetermined relation with the first keyword” is a word that has similar relation with the letters of the first keyword and the meaning of the first keyword, for example. The first retrieving processor 32 retrieves a program whose program information contains the word as a program corresponding to the program preference of the target user. The similarity determination method is not particularly limited. For example, program information that contains the predetermined number of words matching the first keyword may be determined to be similar. Alternatively, program information that contains the predetermined number of words related semantically to the first keyword may be determined to be similar.

The first retrieving processor 32 regards the program IDs retrieved from the viewable program storage 273 as first recommended programs, and stores the first recommended programs in the first recommended program storage 275 in a manner that they are associated with the user ID of the target user. Note that the first keyword extracted based on the viewing history information of the target user may be output from the first retrieving processor 32 to the second retrieving processor 34.

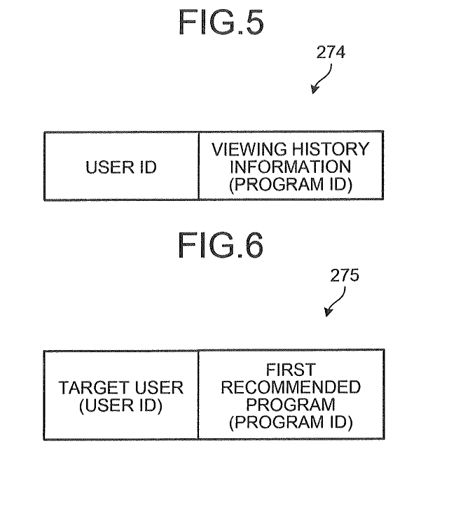

FIG. 6 is a view of an example of a data configuration of the first recommended program storage 275. As illustrated in FIG. 6, the first recommended program storage 275 stores the user ID of the target user and the program ID of the program determined to be a first recommended program in a manner that they are associated with each other.

The similar user retrieving module 33 retrieves other users having program preference similar to that of the target user as similar users based on the program information of programs corresponding to the viewing history information of the target user and the program information of programs corresponding to the viewing history information of users other than the target user that are stored in the viewing history storage 274.

Here, for retrieving processing in the similar user retrieving module 33, a collaborative-filtering-based filtering technique can be used. For example, the similar user retrieving module 33 extracts a keyword (hereinafter referred to as a second keyword) such as of the category or performers of a program from program information of each of the programs corresponding to the viewing history information of the target user. Then, the similar user retrieving module 33 retrieves (specifies), from the viewing history storage 274, the user IDs of other users having, as his/her viewing history information, the program IDs of programs whose program information contains a word that has predetermined relation with the extracted second keyword, as similar users having program preference similar to that of the target user. Note that the relationship (similarity) between the second keyword and the program information of other users may be determined using the same index as in the first retrieving processor 32.

The similar user retrieving module 33 stores the user IDs of the similar users retrieved with respect to the target user in the similar user retrieving result storage 276 together with the viewing history information (program IDs) of the similar users.

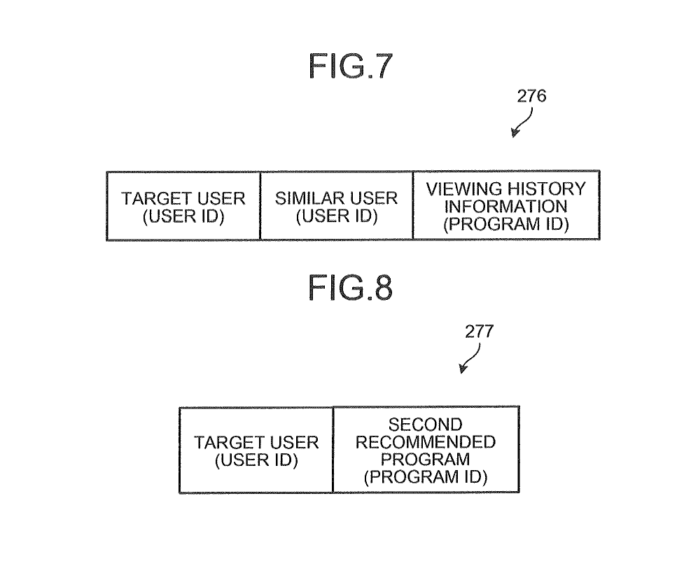

Here, FIG. 7 is a view of an example of a data configuration of the similar user retrieving result storage 276. As illustrated in FIG. 7, the similar user retrieving result storage 276 stores the user ID of the target user, the user ID of the similar user retrieved with respect to the target user, and the viewing history information (program IDs) of the similar user in a manner that they are associated with one another. The viewing history information of the similar user may not be stored in the similar user retrieving result storage 276. Instead, the viewing history storage 274 may be referred to based on the user ID of the similar user.

Note that the timing at which the similar user retrieving module 33 starts retrieving is not particularly limited. For example, when a target user issues an instruction of the providing of recommended programs through the remote controller 23, similar users of the target user may be retrieved (specified). Alternatively, for each of users stored in the user information storage 271, similar users of the user may be retrieved (specified) at predetermined time intervals.

The second retrieving processor 34 retrieves, based on the program information of programs corresponding to the viewing history information of similar users stored in the similar user retrieving result storage 276, programs corresponding to the program preference of the similar users, relative to the target user, from the viewable program storage 273.

Here, for the retrieving processing in the second retrieving processor 34, the contents-based filtering technique same as in the first retrieving processor 32 can be used. Once the second retrieving processor 34 reads out the program information corresponding to the viewing history information of the similar users from the past program storage 272, it extracts, as a keyword (hereinafter referred to as a third keyword), a predetermined word such as of a category, performers, etc. from the program information. Then, the second retrieving processor 34 retrieves, from the viewing history storage 274, the program IDs of the program information containing a word that has predetermined relation with the third keyword extracted, as second recommended programs.

When the configuration is such that a first keyword is input from the first retrieving processor 32, a weighting factor, etc. for the determination of the relationship of a third keyword matching the first keyword may be increased, so that the retrieving is performed with the weighing factor added. Thus, it is possible to preferentially retrieve programs related to the third keyword matching the first keyword among third keywords extracted based on the viewing history information of similar users.

The second retrieving processor 34 stores the second recommended programs retrieved from the viewing history storage 274 with respect to similar users of the target user in the second recommended program storage 277 in a manner that they are associated with the user ID of the target user.

Here, FIG. 8 is a view of an example of a data configuration of the second recommended program storage 277. As illustrated in FIG. 8, the second recommended program storage 277 stores the user ID of the target user and the program ID of the second recommended program retrieved with respect to a similar user of the target user in a manner that they are associated with each other.

The recommended program providing module 35 extracts one part or all of the program IDs of the first recommended programs for the target user stored in the first recommended program storage 275 and the second recommended programs for the target user stored in the second recommended program storage 277, and regards them as recommended programs for the target user. Here, the method of extracting the program IDs determined to be recommended programs is not particularly limited. In the embodiment, the program IDs that are common in both the first recommended programs and the second recommended programs are extracted as recommended programs.

Once the recommended program providing module 35 reads out the program information of the extracted recommended programs (program IDs) from the viewable program storage 273, it cooperates with the synthesis processor 16 so as to superpose, on digital image signals supplied from the signal processor 15, a pair of the program ID and the program information thereof. Thus, the program IDs and the program information of the recommended program are displayed (provided) on the display 30.

Next, the action of the television apparatus 100 of the embodiment is explained.

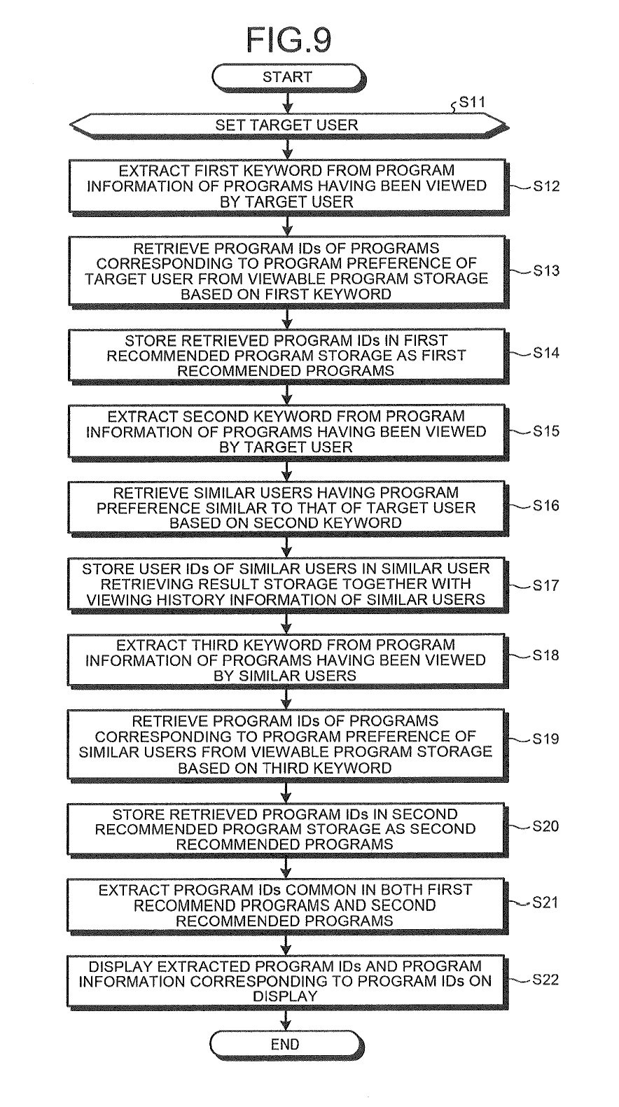

FIG. 9 is a flowchart of steps for recommended program providing processing performed by the television apparatus 100. Note that, as a premise of the main processing, the viewing history information of programs that are viewed by each user is stored in the viewing history storage 274 under control of the viewing history acquiring module 31.

First, in response to an instruction of the providing of a recommended programs through the remote controller 23, etc., the controller 21 sets a user logging in currently as a target user (S11), and starts the following processing. Note that the information (user ID) for identifying the target user is preliminary input when the user starts viewing programs in the television apparatus 100 (logs in the television apparatus 100).

Once the first retrieving processor 32 reads out the program information of each of programs corresponding to the viewing history information (program ID) of the target user that is stored in the viewing history storage 274 from the past program storage 272, it extracts a first keyword from the program information (S12). Next, by using the first keyword extracted at S12, the first retrieving processor 32 retrieves, as first recommended programs, the program IDs of programs corresponding to the program preference of the target user from the viewable program storage 273 (S13). Subsequently, the first retrieving processor 32 stores the first recommended programs retrieved at S13 in the first recommended program storage 275 (S14). Note that the first keyword extracted at S12 may be output to the second retrieving processor 34.

The similar user retrieving module 33 extracts a second keyword from the program information of each of programs corresponding to the viewing history information of the target user (S15). Next, the similar user retrieving module 33 retrieves similar users having program preference similar to that of the target user by using the second keyword extracted at S15 (S16). Subsequently, the similar user retrieving module 33 stores the user IDs of the similar users retrieved at S16 in the similar user retrieving result storage 276 together with the viewing history information of the similar users (S17).

Once the second retrieving processor 34 reads out the program information corresponding to the viewing history information associated with the similar users of the target user, which is stored in the similar user retrieving result storage 276, from the past program storage 272, it extracts a third keyword from each of the program information (S18). Next, by using the third keyword extracted at S18, the second retrieving processor 34 retrieves, as second recommended programs, the program IDs of programs corresponding to the program preference of the similar users from the viewing history storage 274 (S19). Subsequently, the second retrieving processor 34 stores the second recommended programs retrieved at S19 in the second recommended program storage 277 in a manner that they are associated with the user ID of the target user (S20).

The recommended program providing module 35 extracts, as recommended programs, the program IDs that are common in both the first recommended programs for the target user that are stored in the first recommended program storage 275 and the second recommended programs for the target user that are stored in the second recommended program storage 277 (S21). Then, once the recommended program providing module 35 reads out the program information corresponding to the recommended programs extracted at S21 from the viewable program storage 273, it cooperates with the synthesis processor 16 so as to display the programs ID and the program information of the recommended programs on the display 30 (S22), and finishes the main processing.

As described above, the recommended program providing processing employs both the contents-based filtering technique and the collaborative-filtering-based filtering technique, which makes it possible to recommend more variable programs since viewable programs corresponding to the program preference of a target user can be specified not only from the viewpoint of the target user himself/herself but also from the viewpoint of others (similar users).

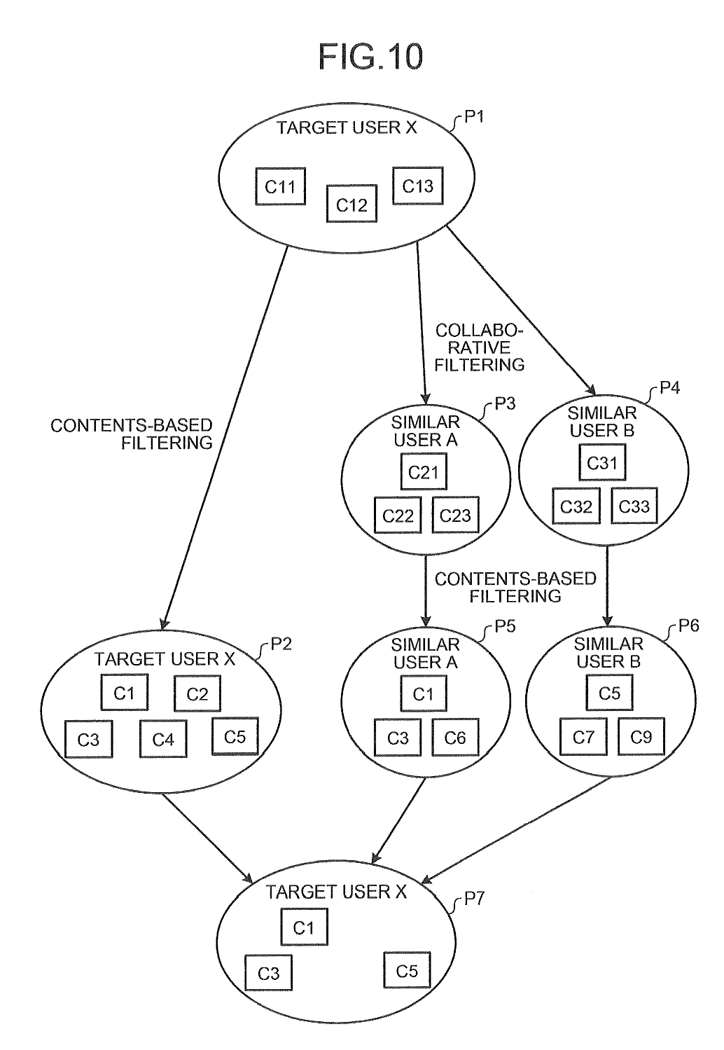

Next, an action example of the recommended program providing processing is described with reference to FIG. 10. FIG. 10 is a view for explaining an action of recommended program providing processing illustrated in FIG. 9. Note that, in FIG. 10, with respect to a target user X, the program IDs “C11 to C13” of the programs viewed by the target user in the past (the programs that cannot be viewed currently) are stored in the viewing history storage 274 (see P1 in FIG. 10).

First, the first retrieving processor 32 performs, at S12 to S14, a contents-based filtering based on the program information of programs corresponding to the viewing history information of the target user X that is stored in the viewing history storage 274, so as to retrieve, as first recommended programs, the program IDs of programs corresponding to the program preference of the target user X from the viewable program storage 273. FIG. 10 illustrates a case in which, for the target user X, the program IDs “C1 to C5” of the programs that are viewable currently are retrieved (see P2 in FIG. 10).

The similar user retrieving module 33 performs, at S15 to S17, a collaborative-filtering-based filtering based on the program information corresponding to the viewing history information of the target user X and the program information corresponding to the viewing history information of other users that are stored in the viewing history storage 274, so as to retrieve (specify) similar users having program preference similar to that of the target user X. Then, the similar user retrieving module 33 stores the user IDs of the similar users in the similar user retrieving result storage 276 together with the viewing history information of the similar users. FIG. 10 illustrates a case in which the program IDs “C21 to C23” are retrieved with respect to the similar user A and the program IDs “C31 to C33” are retrieved with respect to the similar user B (see P3 and P4 in FIG. 10).

Here, the program IDs “C21 to C23”, “C31 to C33” that are retrieved with respect to the similar user A and the similar user B are program IDs of the programs viewed by the similar users in the past. Therefore, the programs cannot be viewed currently even if recommended, and thus the information is useless for selecting a program.

Then, the second retrieving processor 34 performs, at S18 to S20, a contents-based filtering based on the program information of programs corresponding to the viewing history information of the similar users A and B that is stored in the similar user retrieving result storage 276, so as to retrieve, for each similar user, the program IDs of programs corresponding to the program preference of the similar user from the viewable program storage 273 as second recommended programs. Here, the retrieved program IDs are program IDs of programs that are viewable currently. Therefore, the information is useful for selecting a program. FIG. 10 illustrates a case in which the program IDs “C1”, “C3”, “C6” are retrieved based on the program IDs “C21 to C23” with respect to the similar user A and the programs IDs “C5”, “C7”, “C9” are retrieved based on the program IDs “C31 to C33” with respect to the similar user B (see P5 and P6 in FIG. 10).

At S21 and S22, the recommended program providing module 35 extracts, as recommended programs, the program IDs that are common in both the first recommended programs stored in the first recommended program storage 275 and the second recommended programs stored in the second recommended program storage 277. Then, the recommended program providing module 35 displays the program IDs and the program information of the recommended programs on the display 30. FIG. 10 illustrates a case in which, based on the result that the first recommended programs are “C1 to C5” (P2 in FIG. 10) and the second recommended programs are “C1”, “C3”, “C6” (P5 in FIG. 10) and “C5”, “C7”, “C9” (P6 in FIG. 10), “C1”, “C3”, “C5”, which are common in both the first recommended programs and the second recommended programs, are extracted as recommended programs (P7 in FIG. 10).

Thus, in the embodiment, first recommended programs corresponding to the program preference of the target user are retrieved by retrieving processing (contents-based filtering) in the first retrieving processor 32 and, based on the histories of programs viewed by (viewed program histories of) similar users of the target user retrieved by retrieving processing (collaborative-filtering-based filtering) in the second retrieving processor 34, programs corresponding to the program preference of the similar users are retrieved as second recommended programs. Then, one part or all of the first recommended programs and the second recommended programs are provided to the target user as recommended programs.

In this manner, the results of the contents-based filtering and the collaborative-filtering-based filtering can be utilized efficiently. Therefore, it is possible to provide the target user with viewable programs that are more suitable for the program preference of the target user, and thus improve convenience in selecting a program.

While certain embodiments have been described, these embodiments have been provided by way of example only, and are not intended to limit the scope of the invention. Indeed, the embodiments described herein may be embodied in a variety of other forms; furthermore, various omissions, substitutions, changes, and additions may be made without departing from the spirit of the invention. The accompanying claims and their equivalents are intended to cover the embodiments and the modifications thereof as would fall within the scope and spirit of the invention.

For example, in the embodiment, users as targets of retrieving processing (collaborative filtering) in the similar user retrieving module 33 are users of the television apparatus 100 stored in the past program storage 272 (user information storage 271). However, users as targets are not limited thereto, and users of other television apparatuses 100 may be targets for retrieving similar users.

To be more specific, the viewing history information of each user that is obtained in each of the television apparatuses 100 is managed collectively in a server device connected to the network N such as the internet, and the similar user retrieving module 33 performs retrieving processing (collaborative filtering) by using the viewing history information of each user managed by the server device. Thus, the unspecified large number of users can be targets for retrieving similar users. In this case, the similar user retrieving module 33 may be provided on the side of the server device. That is, the user ID of the target user may be notified from each of the television apparatuses 100 to the server device, and then the processing result regarding the target user by the similar user retrieving module 33 may be notified from the server device to the television apparatus 100.

The embodiment exemplifies a case of the television apparatus 100. However, devices to which embodiments are applied are not limited thereto, and may be an information processor, for example, such as a set-top box, a video reproduction device and a personal computer (PC) that are capable of receiving broadcast signals of each program.

The programs executed in the television apparatus 100 in the embodiment are preliminarily embedded in the recording medium (ROM 212 or HDD 27) of the television apparatus 100, and then provided. However, the method of providing programs is not limited thereto. The programs executed in the television apparatus 100 in the embodiment may be recorded, as a file whose format is installable or executable, in a computer readable recording medium such as a flexible disk (FD) or the optical disk 26, and then provided. Furthermore, the recording medium is not limited to a medium independent of the computer or the embedded system. The recording medium may be a medium storing or temporarily storing therein a program that is transmitted through a local area network (LAN), the Internet, etc. and then downloaded.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a viewing history acquiring module configured to acquire, as a viewing history, program contents of a program viewed by each of a plurality of users;
a first retrieving module configured to retrieve, based on a viewing history of a target user among the plurality of users, a program corresponding to program preference of the target user, from a viewable program storage storing therein programs that are viewable;
a similar user retrieving module configured to retrieve, based on the viewing history of the target user and viewing histories of users other than the target user among the plurality of users, a similar user having program preference similar to the program preference of the target user, from the users other than the target user;
a second retrieving module configured to retrieve, based on a viewing history of the similar user, a program corresponding to the program preference of the similar user, from the viewable program storage; and
a providing module configured to provide one part or all of the programs retrieved by the first retrieving module and the second retrieving module.

2. The information processor of claim 1, wherein the providing module is configured to provide a common program that is retrieved by both the first retrieving module and the second retrieving module.

3. The information processor of claim 1, wherein the first retrieving module is configured to retrieve a program that has a predetermined relationship with program contents of each of programs contained in the viewing history of the target user, from the viewable program storage.

4. The information processor of claim 1, wherein the similar user retrieving module is configured to retrieve, as the similar user, another user having, in the viewing history of the another user, a program that has a predetermined relationship with program contents of each of programs contained in the viewing history of the target user.

5. The information processor of claim 1, wherein the second retrieving module is configured to retrieve a program that has a predetermined relationship with program contents of each of programs contained in the viewing history of the similar user, from the viewable program storage.

6. The information processor of claim 1, wherein the first retrieving module, the similar user retrieving module, and the second retrieving module are configured to extract a predetermined keyword from program contents of each of programs contained in the viewing history to retrieve an object that has a predetermined relationship with the keyword.

7. The information processor of claim 6, wherein the second retrieving module is configured to increase a weighing factor related to determination of relationship with the keyword extracted by the first retrieving module to retrieve a program corresponding to the program preference of the similar user with the weighing factor of the keyword added.

8. A broadcast receiving device comprising:
a receiver configured to receive broadcast signals of programs broadcasted in plurality of channel;
a program guide acquiring module configured to acquire, from the broadcast signals, a program guide containing program information of each of programs that are currently broadcasted and programs that are scheduled to be broadcasted in a future;
a viewing history acquiring module configured to acquire, as a viewing history, program contents of a program viewed by each of a plurality of users;
a first retrieving module configured to retrieve, based on a viewing history of a target user among the plurality of users, a program corresponding to program preference of the target user, from a viewable program storage storing therein programs that are viewable;
a similar user retrieving module configured to retrieve, based on the viewing history of the target user and viewing histories of users other than the target user among the plurality of users, a similar user having program preference similar to the program preference of the target user, from the users other than the target user;
a second retrieving module configured to retrieve, based on a viewing history of the similar user, a program corresponding to the program preference of the similar user, from the viewable program storage; and
a providing module configured to provide one part or all of the programs retrieved by the first retrieving module and the second retrieving module.

9. An information processing method comprising:
acquiring, by a viewing history acquiring module, as a viewing history, program contents of a program viewed by each of a plurality of users;
first retrieving, by a first retrieving module, based on a viewing history of a target user among the plurality of users, a program corresponding to program preference of the target user, from a viewable program storage storing therein programs that are viewable;
second retrieving, by a similar user retrieving module, based on the viewing history of the target user and viewing histories of users other than the target user among the plurality of users, a similar user having program preference similar to the program preference of the target user, from the users other than the target user;
third retrieving, by a second retrieving module, based on a viewing history of the similar user, a program corresponding to the program preference of the similar user, from the viewable program storage; and
providing, by a providing module, one part or all of the programs retrieved by the first retrieving module and the second retrieving module.
